(19) United States
(12) Patent Application Publication
(10) Pub. No.: US 2025/0384671 A1
(43) Pub. Date: Dec. 18, 2025

(54) TRAINING METHOD OF DEPTH ESTIMATION MODEL, TERMINAL AND STORAGE MEDIUM

(71) Applicant: Beijing Zitiao Network Technology Co., Ltd., Beijing (CN)

(72) Inventors: Guangyuan ZHOU, Beijing (CN); Zhengxin LI, Beijing (CN); Qiang RAO, Beijing (CN); Xiao LIU, Beijing (CN)

(21) Appl. No.: 19/240,886

(22) Filed: Jun. 17, 2025

(30) Foreign Application Priority Data
Jun. 17, 2024 (CN) 202410780523.6

(51) Int. Cl. G06V 10/774; G06T 7/50; G06V 10/72; G06V 10/74; G06V 10/762

(52) U.S. Cl. CPC G06V 10/774; G06T 7/50; G06V 10/72; G06V 10/761; G06V 10/762; G06T 2207/20081; G06T 2207/30168

(57) ABSTRACT

A training method of depth estimation model, terminal and storage medium are provided by the present disclosure. The method includes: acquiring selective depth data; training the depth estimation model by using the selective depth data to obtain a trained depth estimation model; where the acquiring selective depth data includes: acquiring a depth data set; performing quality assessment on the depth data set to obtain first depth data; performing mean-shift on the first depth data to obtain second depth data; performing fine-tuning on a pre-training depth model by using the second depth data to obtain a metric depth model; and performing necessity assessment on the first depth data by using the metric depth model to obtain the selective depth data.

This application claims the priority to and benefits of the Chinese Patent Application, No. 202410780523.6, which was filed on Jun. 17, 2024, which is incorporated herein by reference in its entirety.

### TECHNICAL FIELD

The present disclosure relates to the technical field of information, in particular to a training method and apparatus of a depth estimation model, a terminal and a storage medium.

### BACKGROUND

Monocular depth estimation refers to inputting an image and predicting the distance of each pixel in the image relative to the camera, which is different from traditional viewing angle matching or triangulation solution methods. Self-supervision scheme based on learning and supervision scheme based on the relative depth of large-scale data have made remarkable progress in this field.

In related methods, first a large amount of data is used for pre-training to obtain a relative depth model, and then a small amount of data is used for fine-tuning to obtain a metric depth model, so that the generalization ability of the model in coarse scenes (e.g., indoor and outdoor) is improved. However, how to make the model achieve ideal results in various subdivided scenes at the same time is still a challenging problem.

### SUMMARY

In order to solve the above-mentioned problem, the present disclosure provides a training method and apparatus of a depth estimation model, a terminal and a storage medium.

The embodiment of the present disclosure provides a training method of a depth estimation model, including: acquiring selective depth data; training the depth estimation model by using the selective depth data to obtain a trained depth estimation model; where the acquiring the selective depth data includes: acquiring a depth data set; performing quality assessment on the depth data set to obtain first depth data; performing mean-shift on the first depth data to obtain second depth data; performing fine-tuning on a pre-training depth model by using the second depth data to obtain a metric depth model; and performing necessity assessment on the first depth data by using the metric depth model to obtain the selective depth data.

Another embodiment of the present disclosure provides a training apparatus, including: a selective depth data acquisition module, configured to acquire selective depth data; and a training module, configured to train a depth estimation model by using the selective depth data to obtain a trained depth estimation model; where the selective depth data acquisition module is further configured to: acquire a depth data set; perform quality assessment on the depth data set to obtain first depth data; perform mean-shift on the first depth data to obtain second depth data; perform fine-tuning on a pre-training depth model by using the second depth data to obtain a metric depth model; and perform necessity assessment on the first depth data by using the metric depth model to obtain the selective depth data.

Another embodiment of the present disclosure provides a training method of a depth estimation model, including: determining a joint supervision function, where the joint supervision function includes a gradient angle function, the gradient angle function constrains an absolute error loss between angles of a depth gradient in length and width directions and an angle of a true depth gradient; and training the depth estimation model by using the joint supervision function to obtain a trained depth estimation model.

Another embodiment of the present disclosure provides a training apparatus of a depth estimation model, including: a function determination module, configured to determine a joint supervision function, where the joint supervision function includes a gradient angle function, the gradient angle function constrains an absolute error loss between angles of a depth gradient in length and width directions and an angle of a true depth gradient; and a training module, configured to train the depth estimation model by using the joint supervision function to obtain a trained depth estimation model.

In some embodiments, the present disclosure provides a terminal, including: at least one memory and at least one processor; where the at least one memory is configured to store program code, and the at least one processor is configured to call the program code stored by the at least one memory to execute the above-mentioned training method of the depth estimation model.

In some embodiments, the present disclosure provides a storage medium, where the storage medium is configured to storage program code, and the program code is configured to execute the above-mentioned training method of the depth estimation model.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and components and elements may not necessarily be drawn to scale.

FIG. 1 is a flow diagram of a training method of a depth estimation model in the embodiment of the present disclosure.

FIG. 2 is a schematic flow diagram of acquiring selective depth data in the embodiment of the present disclosure.

FIG. 3 shows a schematic diagram of a depth gradient angle in the embodiment of the present disclosure.

FIG. 4 shows part of modules of a training apparatus of a depth estimation model in the embodiment of the present disclosure.

FIG. 5 is a flow diagram of a training method of a depth estimation model in another embodiment of the present disclosure.

FIG. 6 shows part of modules of a training apparatus of a depth estimation model in another embodiment of the present disclosure.

FIG. 7 is a structural schematic diagram of an electronic device in the embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be executed sequentially and/or in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” mentioned in the present disclosure are schematic rather than restrictive, and those skilled in the art should understand that unless otherwise explicitly stated in the context, it should be understood as “one or more”.

The names of the messages or information exchanged between a plurality of apparatuses in the embodiments of the present disclosure are for illustrative purposes only and are not intended to limit the scope of these messages or information.

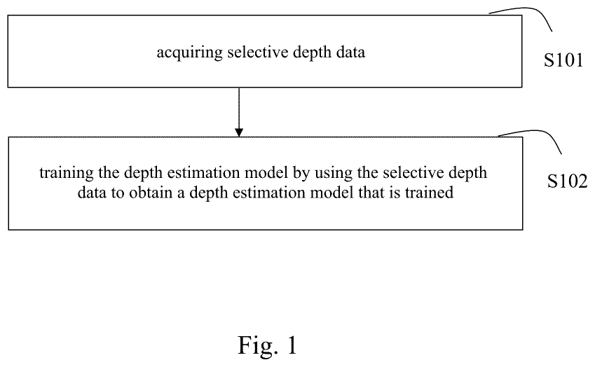

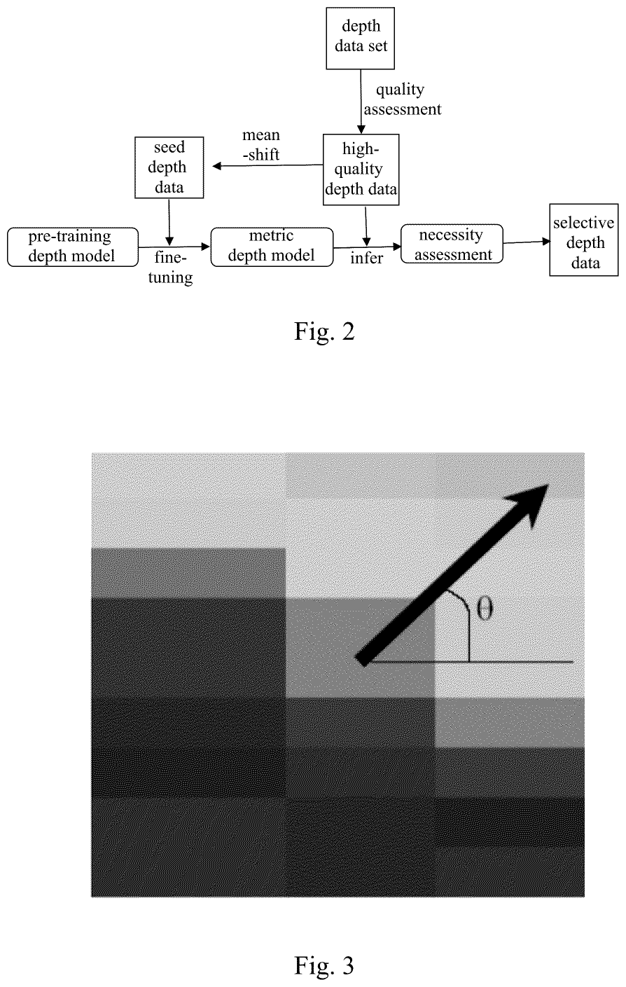

FIG. 1 provides a flow diagram of a training method of a depth estimation model in the embodiment of the present disclosure. The training method of the depth estimation model in the present disclosure may include a step S101 of acquiring selective depth data. FIG. 2 is a schematic flow diagram of acquiring selective depth data in the embodiment of the present disclosure. Referring to FIG. 2, in some embodiments, acquiring selective depth data includes: acquiring a depth data set; performing quality assessment on the depth data set to obtain first depth data; performing mean-shift on the first depth data to obtain second depth data; performing fine-tuning on a pre-training depth model by using the second depth data to obtain a metric depth model; and performing necessity assessment on the first depth data by using the metric depth model to obtain the selective depth data.

In some embodiments, the depth data set may be any suitable public data set, such as KITTI, Cityscapes, etc. In some embodiments, quality assessment is performed on the depth data set to obtain first depth data (high-quality depth data in FIG. 2). In some embodiments, after the high-quality depth data is obtained by screening, mean-shift algorithm clustering is performed on the first depth data to obtain second depth data (seed depth data in FIG. 2). Referring to FIG. 2, in some embodiments, a pre-training depth model is fine-tuned by using the second depth data to obtain a metric depth model. In some embodiments, the pre-training depth model is an existing model for obtaining selective depth data. For example, the pre-training depth model may be depth-anything (a relative depth model), and the metric depth model is obtained after performing fine-tuning on the seed depth data. Then, necessity assessment is performed on the first depth data (high-quality depth data) by using the metric depth model to abandon unnecessary data and obtain the selective depth data. In some embodiments, the selective depth data includes a plurality of images and distance data of each pixel in the respective image relative to the camera. In some embodiments, the images are monocular images.

In some embodiment, the method in the present disclosure may include a step S102 of training the depth estimation model by using the selective depth data to obtain a trained depth estimation model. The depth estimation model is trained by using selective depth data, so that the generalization ability of the model in various subdivided scenes is significantly improved. In some embodiments, the depth estimation model in the present disclosure is a monocular depth estimation model.

In some embodiments, high-quality depth data should satisfy coverage, accuracy and necessity. First, the depth data used for training should cover enough scenes to improve the generalization ability of the model in various scenes. Secondly, the quality of true labels of the depth data used for training should be high enough to improve the accuracy of model training. Finally, the depth data used for training should not contain too much redundant data, otherwise the model will show ill-conditioned behaviors. As mentioned above, in the embodiments of the present disclosure, after high-quality depth data is obtained by screening, representative depth data (seed depth data) of the data set may be obtained by mean-shift algorithm clustering. Based on the pre-training depth model and the seed depth data, a metric depth model may be obtained. Next, necessity assessment is performed on the high-quality depth data by using the metric depth model, and finally a small part of covered, necessary and accurate depth data, that is, selective depth data, may be obtained. The performance of selective depth data screened through the above-mentioned strategies is better than that of directly mixing multiple data.

In some embodiments, performing quality assessment on the depth data set to obtain first depth data includes: training a known model (such as depth-anything) by using the depth data set, and assessing the quality of the depth data set based on zero-shot result data of the known model on different depth data sets, and coverage, density and quantity corresponding to the depth data set. It should be understood that other known depth estimation models may be adopted in the quality assessment process. For example, Table 1 shows the evaluation results of public depth data sets on multiple Benchmarks, and Table 2 shows the results of the density, coverage and quantity of the public depth data sets.

TABLE 1

| Training | KITTI | | VKITTI2 | | Cityscapes | | Diode | | NYUv2 | | Mean | |
|---|---|---|---|---|---|---|---|---|---|---|---|---|
| set | δ₁ | F | δ₁ | F | δ₁ | F | δ₁ | F | δ₁ | F | δ₁ | F |
| KITTI | 0.968 | 44.77 | 0.841 | 29.75 | 0.932 | 17.92 | 0.256 | 5.434 | 0.121 | 7.828 | 0.623 | 21.14 |
| Cityscapes | 0.94 | 25.88 | 0.833 | 21.43 | 0.985 | 51.17 | 0.406 | 7.24 | 0.091 | 6.943 | 0.651 | 22.53 |
| DDAD | 0.659 | 6.96 | 0.49 | 5.369 | 0.193 | 1.877 | 0.301 | 6.187 | 0.074 | 6.87 | 0.343 | 5.45 |
| Uasol | 0.766 | 18.43 | 0.652 | 17.1 | 0.772 | 26.40 | 0.371 | 6.951 | 0.024 | 2.878 | 0.517 | 14.35 |
| Argoverse | 0.753 | 19.59 | 0.815 | 23.04 | 0.769 | 6.521 | 0.265 | 3.71 | 0.302 | 17.81 | 0.581 | 14.13 |
| Dsec | 0.169 | 2.543 | 0.194 | 4.65 | 0.503 | 2.917 | 0.274 | 6.328 | 0.105 | 8.345 | 0.249 | 4.96 |

TABLE 2

| | | | | | Acquisition |
|---|---|---|---|---|---|
| Data | Density | Coverage | Quantity | | method |
| Cityscapes | 82.5% | 50 city, diverse | 15 | W | SGM |
| | | seasons | | | |
| Dsec | 7.4% | 3 city, 41 sequences | 2.6 | W | SGM + Lidar |
| KITTI | 15.2% | 1 city, 76 sequences | 2.3 | W | SGM + Lidar |
| NYU v2 | 67.6% | 3 city, 464 scenes | 2.4 | W | Kinect |

Therefore, in the embodiments of the present disclosure, a public data set is used to train a model, and the quality of the data set is judged based on the zero-shot result data of the model on different test data. Overall assessment is performed on the quality of the depth data set in combination with the zero-shot result data and the coverage, label density and quantity corresponding to the depth data set.

In some embodiments, performing mean-shift on the first depth data to obtain second depth data includes: initializing a bandwidth threshold; taking, based on a Gaussian function, a weighted average value of distances between a current data point and data points within a range corresponding to the bandwidth threshold as a current density value, where the size of the weight are inversely proportional to the distances between data points and the current point; updating all data points according to the weighted average value, after multiple iterations, determining converged points as clustering centers, and classifying points converging to the same clustering center into one cluster; and for a clustering center of each cluster, determining cosine similarity between the clustering center and each data point, and selecting the data that is most similar to the clustering center to obtain the second depth data. In some embodiments, after the high-quality depth data is obtained, the high-quality depth data is fed to a monocular depth pre-training network (such as depth-anything), and a feature map of the data is extracted based on the pre-training network. After downsampling high-dimensional image features, the mean-shift, which is a density-based non-parametric clustering algorithm, is used to, without specifying the quantity of clusters in advance, determine the clustering center of the current data by searching the local maximum value point of the density function and screen seed depth data. In some embodiments, the bandwidth threshold is used to control the sensitivity of clustering. A smaller threshold will lead to more small clusters, while a larger threshold will lead to sparser and coarser clusters. The user may select and adjust the threshold according to the desired quantity of clusters.

In some embodiment, performing necessity assessment on the first depth data by using the metric depth model to obtain the selective depth data includes: inputting the first depth data into the metric depth model, and determining data having a data error predicted by the metric depth model higher than or equal to a preset threshold as the selective depth data. In some embodiments, the preset threshold is, for example, 0.1. If the data error predicted by the metric depth model is lower than the mean absolute error (MAE) threshold of 0.1, the depth data is determined to be non-essential data. If the error is greater than or equal to the threshold, the depth data is determined to be essential data (i.e., selective depth data).

In some embodiments, training the depth estimation model by using the selective depth data includes: training the depth estimation model by using the selective depth data and a joint supervision function, where the joint supervision function includes a gradient angle function, the gradient angle function constrains an absolute error loss between angles of a depth gradient in length and width directions and an angle of a true depth gradient. In some embodiments, the gradient angle function is used for model training supervision, and based on the gradient angle function, the model is significantly improved in the point cloud reconstruction F-score index, which means that the accuracy of the depth estimated by the model in 3D reconstruction is improved.

In related schemes, the gradient of a depth map is directly used to supervise the edge information of the model, which will lose the orientation information hidden in the image. The depth estimation model may predict more accurate three-dimensional point cloud structure by using the implicit orientation information. In the edge area of an object, the depth estimation model may learn the depth change trend, making the predicted edge area of the three-dimensional point cloud clearer. In some embodiments, the angle corresponding to the gradient in the depth map is defined as

$$θ = α tan 2 ( \frac{\partial d}{\partial y} , \frac{\partial d}{\partial x} ) ,$$

and the schematic diagram is as shown in FIG. 3. When the true depth label d and the predicted depth d* are given, the gradient angle function is defined as follows:

$${L}_{angle} = {\sum }_{i = 1}^{M} \vert α tan 2 ( \frac{\partial {d}_{i}}{\partial y} , \frac{\partial {d}_{i}}{\partial x} ) - α tan 2 ( \frac{\partial {d}_{i}}{\partial y} , \frac{\partial {d}_{i}^{*}}{\partial x} ) \vert$$

wherein i represents each pixel, d represents a depth, and a tan 2 represents an arctangent function. The gradient angle loss function may effectively improve the edge sharpness of the predicted depth of the model and the point cloud reconstruction accuracy (measured by F-Score) by constraining the L1 loss (absolute error loss) between the angles of the depth gradient in x and y (length, width) directions and the angle of the true depth gradient.

In some embodiment, the joint supervision function also includes a scale shift invariant loss function, a scale-invariant logarithmic loss function and a random proposal normalization loss function. These functions are also used to supervise the training of the depth estimation model.

In some embodiments, the scale shift invariant loss function decouples the scale and shift for optimizing the depth distribution of a single image;

$${L}_{SSI} ( \hat{d} , {\hat{d}}^{*} ) = \frac{1}{2 M} {\sum }_{i = 1}^{M} ρ ( {\hat{d}}_{i} - {\hat{d}}_{i}^{*} ) , ( s , t ) = arg {min}_{s , t} {\sum }_{i = 1}^{M} {( s {d}_{i} + t - {d}_{i}^{*} )}^{2} , \hat{d} = s d + t , {\hat{d}}^{*} = {d}^{*}$$

wherein, ρ presents the loss function between true depth label \hat{d}*ᵢ of the shift and the predicted depth \hat{d}ᵢ of the shift, and i represent each pixel. The scale and translation are obtained by using the least square fitting to predict the depth d and the true depth label d*, wherein scale is represented by s, and translation is represented by t.

In some embodiments, the scale-invariant logarithmic loss function is mainly used to solve the problem of scale inconsistency in different scenes;

$${L}_{SILog} = \frac{1}{M} {\sum }_{i} {( log ( {d}_{i} ) - log ( {d}_{i}^{*} ) )}^{2} - \frac{1}{{M}^{2}} {( {\sum }_{i} ( log ( {d}_{i} ) - log ( {d}_{i}^{*} ) ) )}^{2}$$

wherein i represents each pixel, and the quantity of overall pixels is M.

In some embodiments, the random proposal normalization loss function is used to increase the contrast of local regions of the depth map;

$${L}_{RPNL} = \frac{1}{PN} {\sum }_{{p}_{i}}^{P} {\sum }_{j}^{N} \frac{{d}_{{p}_{i , j}}^{*} - μ ( {d}_{{p}_{i , j}}^{*} )}{\frac{1}{N} {\sum }_{j}^{N} \vert {d}_{{p}_{i , j}}^{*} - μ ( {d}_{{p}_{i , j}}^{*} ) \vert} - \frac{{d}_{{p}_{i , j}} - μ ( {d}_{{p}_{i , j}} )}{\frac{1}{N} {\sum }_{j}^{N} \vert {d}_{{p}_{i , j}} - μ ( {d}_{{p}_{i , j}} ) \vert}$$

wherein, pᵢ represents patches randomly cropped from the image, the total quantity of the patches is P, the total quantity of pixels corresponding to each patch is N, the corresponding pixel is j, and μ represents the mean function.

Therefore, the overall supervision function of the depth estimation model is as follows:

$$L = {L}_{SILog} + {L}_{SSI} + {L}_{RPNL} + λ {L}_{angle}$$

In some embodiments, the trained depth estimation model is obtained by training based on the depth-anything network structure by using the above-mentioned designed loss function and the screened selective depth data. In some embodiments, some model parameters are set during training. For example, the batch-size is set to 16, the learning rate is set to 0.000161, the input learning rate is set to 384×768, and the quantity of training epochs is set to 4.

The training method in the present disclosure can improve the generalization ability of the depth estimation model in complex scenes by adopting the selective depth data that has been screened with high quality, which enables the depth model to achieve excellent performance in multiple subdivided scenes (indoor and outdoor) at the same time. In addition, the present disclosure can improve the three-dimensional point cloud reconstruction accuracy based on depth estimation by adopting the joint supervision function including the gradient angle function, so that the depth model can obtain better three-dimensional scene structure information in various different scenes. In addition, the depth estimation model in the present disclosure is significantly improved in the point cloud reconstruction F-score index, which means that the accuracy of the depth estimated by the model in 3D reconstruction is improved.

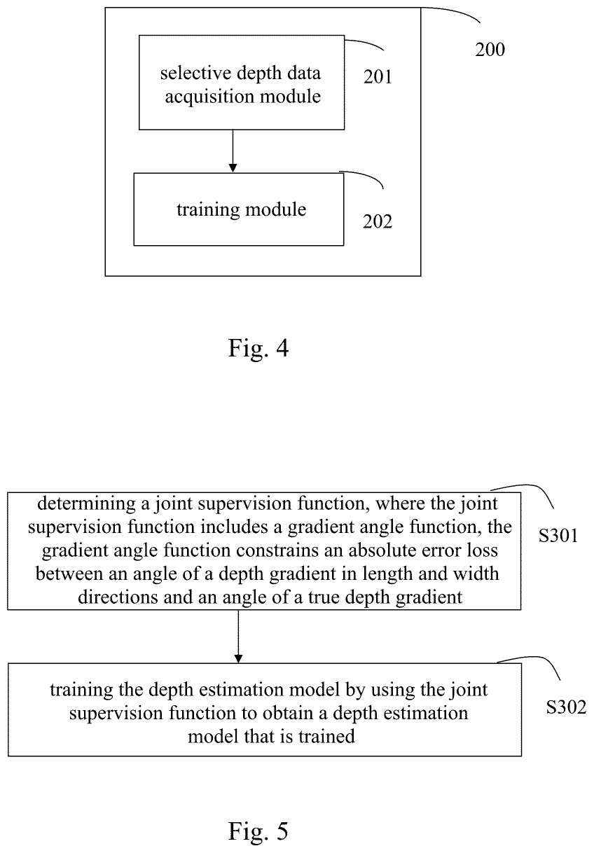

The embodiment of the present disclosure also provides a training apparatus 200 of a depth estimation model. FIG. 4 shows a training apparatus 200 of a depth estimation model according to some embodiments. The training apparatus 200 of the depth estimation model includes a selective depth data acquisition module 201 and a training module 202. In some embodiments, the selective depth data acquisition module 201 is configured to acquire selective depth data. In some embodiments, the training module 202 is configured to train the depth estimation model by using the selective depth data to obtain a trained depth estimation model. In some embodiments, acquiring selective depth data includes: acquiring a depth data set; performing quality assessment on the depth data set to obtain first depth data; performing mean-shift on the first depth data to obtain second depth data; performing fine-tuning on a pre-training depth model by using the second depth data to obtain a metric depth model; and performing necessity assessment on the first depth data by using the metric depth model to obtain the selective depth data.

It should be understood that what has been described by using respect to the training method of a depth estimation model is also applicable to the training apparatus 200 for a depth estimation model herein, and will not be described in detail herein for the sake of simplicity.

In some embodiments, performing quality assessment on the depth data set to obtain first depth data includes: training a known model by using the depth data set, and assessing a quality of the depth data set based on zero-shot result data of the known model on different depth data sets, and coverage, density and quantity corresponding to the depth data set. In some embodiments, performing mean-shift on the first depth data to obtain second depth data includes: initializing a bandwidth threshold; taking, based on a Gaussian function, a weighted average value of distances between a current data point and data points within a range corresponding to the bandwidth threshold as a current density value; updating all data points according to the weighted average value, after multiple iterations, determining converged points as clustering centers, and classifying points converging to the same clustering center into one cluster; and for a clustering center of each cluster, determining cosine similarity between the clustering center and each data point, and selecting the data that is most similar to the clustering center to obtain the second depth data. In some embodiment, performing necessity assessment on the first depth data by using the metric depth model to obtain the selective depth data includes: inputting the first depth data into the metric depth model, and determining data having a data error predicted by the metric depth model higher than or equal to a preset threshold as the selective depth data. In some embodiments, training the depth estimation model by using the selective depth data includes: training the depth estimation model by using the selective depth data and a joint supervision function, where the joint supervision function includes a gradient angle function, the gradient angle function constrains an absolute error loss between angles of a depth gradient in length and width directions and an angle of a true depth gradient. In some embodiment, the joint supervision function also includes a scale shift invariant loss function, a scale-invariant logarithmic loss function and a random proposal normalization loss function.

FIG. 5 provides a flow diagram of a training method of a depth estimation model in the embodiment of the present disclosure. The training method of the depth estimation model in the present disclosure may include a step S301 of determining a joint supervision function, where the joint supervision function includes a gradient angle function, the gradient angle function constrains an absolute error loss between angles of a depth gradient in length and width directions and an angle of a true depth gradient. In some embodiments, the gradient angle function is used for model training supervision, and based on the gradient angle function, the model is significantly improved in the point cloud reconstruction F-score index, which means that the accuracy of the depth estimated by the model in 3D reconstruction is improved.

In related schemes, the gradient of a depth map is directly used to supervise the edge information of the model, which will lose the orientation information hidden in the image. The depth estimation model may predict more accurate three-dimensional point cloud structure by using the implicit orientation information. In the edge area of an object, the depth estimation model may learn the depth change trend, making the predicted edge area of the three-dimensional point cloud clearer. In some embodiments, the angle corresponding to the gradient in the depth map is defined as

$$θ = α tan 2 ( \frac{\partial d}{\partial y} , \frac{\partial d}{\partial x} ) ,$$

and the schematic diagram is as shown in FIG. 3. When the true depth label d and the predicted depth d* are given, the gradient angle function is defined as follows:

$${L}_{angle} = {\sum }_{i = 1}^{M} \vert α tan 2 ( \frac{\partial {d}_{i}}{\partial y} , \frac{\partial {d}_{i}}{\partial x} ) - α tan 2 ( \frac{\partial {d}_{i}}{\partial y} , \frac{\partial {d}_{i}^{*}}{\partial x} ) \vert$$

wherein i represents each pixel, d represents a depth, and a tan 2 represents an arctangent function. The gradient angle loss function may effectively improve the edge sharpness of the predicted depth of the model and the point cloud reconstruction accuracy (measured by F-Score) by constraining the L1 loss (absolute error loss) between the angles of the depth gradient in x and y (length, width) directions and the angle of the true depth gradient.

In some embodiment, the method in the present disclosure may include a step S302 of training the depth estimation model by using the joint supervision function to obtain a trained depth estimation model. The three-dimensional point cloud reconstruction accuracy based on depth estimation can be improved by adopting the joint supervision function including the gradient angle function, so that the depth model can obtain better three-dimensional scene structure information in various different scenes, and the problem that the depth of the related depth estimation model is insufficient in 3D reconstruction accuracy.

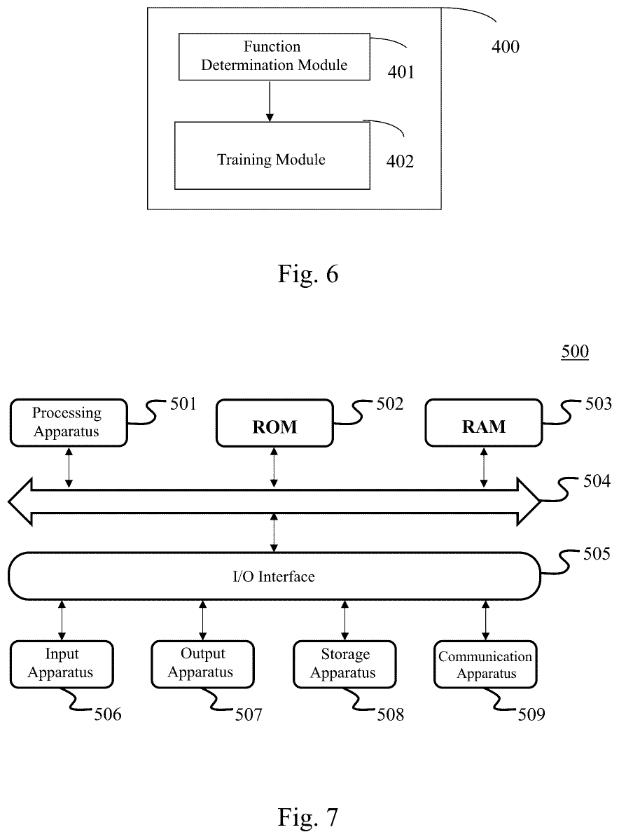

The embodiment of the present disclosure also provides a training apparatus 400 of a depth estimation model. FIG. 6 shows a training apparatus 400 of a depth estimation model according to some embodiments. The training apparatus 400 of the depth estimation model includes a function determination module 401 and a training module 402. In some embodiments, the function determination module 401 is configured to determine a joint supervision function, where the joint supervision function includes a gradient angle function, the gradient angle function constrains an absolute error loss between angles of a depth gradient in length and width directions and an angle of a true depth gradient. In some embodiments, the training module 402 is configured to train the depth estimation model by using the joint supervision function to obtain a trained depth estimation model.

It should be understood that what has been described by using respect to the training method of a depth estimation model is also applicable to the training apparatus 400 for a depth estimation model herein, and will not be described in detail herein for the sake of simplicity.

In addition, the present disclosure also provides a terminal. The terminal includes at least one memory and at least one processor, where the memory is configured to store program code, and the processor is configured to call the program code stored by the memory to execute the above-mentioned training method of a depth estimation model.

In addition, the present disclosure also provides a computer storage medium. The storage medium is configured to storage program code, and the program code is used for executing the above-mentioned training method of a depth estimation model.

The training method and apparatus of the depth estimation model in the present disclosure have been described above based on the embodiments and examples. In addition, the present disclosure also provides a terminal and a storage medium, and the terminal and the storage media will be described below.

Referring to FIG. 7, FIG. 7 illustrates a schematic structural diagram of an electronic device (eg, a terminal device or a server) 500 suitable for implementing the embodiments of the present disclosure. The terminal devices in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 7 is merely an example, and should not pose any limitation to the functions and the range of use of the embodiments of the present disclosure.

As illustrated in FIG. 7, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected through a bus 504. An input/output (I/O) interface 505 is also connected to the bus 504.

Usually, the following apparatuses may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 7 illustrates the electronic device 500 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the above-mentioned method of the present disclosure.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a training method of a depth estimation model is provided, including: acquiring selective depth data; training the depth estimation model by using the selective depth data to obtain a trained depth estimation model; where the acquiring the selective depth data includes: acquiring a depth data set; performing quality assessment on the depth data set to obtain first depth data; performing mean-shift on the first depth data to obtain second depth data; performing fine-tuning on a pre-training depth model by using the second depth data to obtain a metric depth model; and performing necessity assessment on the first depth data by using the metric depth model to obtain the selective depth data.

According to one or more embodiments of the present disclosure, the performing quality assessment on the depth data set to obtain first depth data includes: training a known model by using the depth data set, and assessing a quality of the depth data set based on zero-shot result data of the known model on different depth data sets, and coverage, density and quantity corresponding to the depth data set.

According to one or more embodiments of the present disclosure, the performing mean-shift on the first depth data to obtain second depth data includes: initializing a bandwidth threshold; taking, based on a Gaussian function, a weighted average value of distances between a current data point and data points within a range corresponding to the bandwidth threshold as a current density value; updating all data points according to the weighted average value, after multiple iterations, determining converged points as clustering centers, and classifying points converging to a same clustering center into one cluster; and for a clustering center of each cluster, determining cosine similarity between the clustering center and each data point, and selecting data that is most similar to the clustering center to obtain the second depth data.

According to one or more embodiments of the present disclosure, the performing necessity assessment on the first depth data by using the metric depth model to obtain the selective depth data includes: inputting the first depth data into the metric depth model, and determining data having a data error predicted by the metric depth model higher than or equal to a preset threshold as the selective depth data.

According to one or more embodiments of the present disclosure, the training the depth estimation model by using the selective depth data includes: training the depth estimation model by using the selective depth data and a joint supervision function, where the joint supervision function includes a gradient angle function, the gradient angle function constrains an absolute error loss between angles of a depth gradient in length and width directions and an angle of a true depth gradient.

According to one or more embodiments of the present disclosure, the joint supervision function further includes a scale shift invariant loss function, a scale-invariant logarithmic loss function and a random proposal normalization loss function.

According to one or more embodiments of the present disclosure, a training method of a depth estimation model is provided, including: determining a joint supervision function, where the joint supervision function includes a gradient angle function, the gradient angle function constrains an absolute error loss between angles of a depth gradient in length and width directions and an angle of a true depth gradient; and training the depth estimation model by using the joint supervision function to obtain a trained depth estimation model.

According to one or more embodiments of the present disclosure, a training apparatus of a depth estimation model is provided, including: a selective depth data acquisition module, configured to acquire selective depth data; and a training module, configured to train the depth estimation model by using the selective depth data to obtain a trained depth estimation model; where the selective depth data acquisition module is further configured to: acquire a depth data set; perform quality assessment on the depth data set to obtain first depth data; perform mean-shift on the first depth data to obtain second depth data; perform fine-tuning on a pre-training depth model by using the second depth data to obtain a metric depth model; and perform necessity assessment on the first depth data by using the metric depth model to obtain the selective depth data.

According to one or more embodiments of the present disclosure, a training apparatus of a depth estimation model is provided, including: a function determination module, configured to determine a joint supervision function, where the joint supervision function includes a gradient angle function, the gradient angle function constrains an absolute error loss between angles of a depth gradient in length and width directions and an angle of a true depth gradient; and a training module, configured to train the depth estimation model by using the joint supervision function to obtain a trained depth estimation model.

According to one or more embodiments of the present disclosure, a terminal is provided, including: at least one memory and at least one processor; where, the at least one memory is configured to store program code, and the at least one processor is configured to call the program code stored by the at least one memory to execute the any one of the training method of the depth estimation model above.

According to one or more embodiments of the present disclosure, a storage medium is provided. The storage medium is configured to storage program code, and the program code is configured to execute the above-mentioned training method of the depth estimation model.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A training method of a depth estimation model, comprising:
acquiring selective depth data;
training the depth estimation model by using the selective depth data to obtain a trained depth estimation model;
wherein the acquiring selective depth data comprises:
acquiring a depth data set;
performing quality assessment on the depth data set to obtain first depth data;
performing mean-shift on the first depth data to obtain second depth data;
performing fine-tuning on a pre-training depth model by using the second depth data to obtain a metric depth model; and
performing necessity assessment on the first depth data by using the metric depth model to obtain the selective depth data.

2. The training method of the depth estimation model according to claim 1, wherein the performing quality assessment on the depth data set to obtain first depth data comprises:
training a known model by using the depth data set, and assessing a quality of the depth data set based on zero-shot result data of the known model on different depth data sets, and coverage, density and quantity corresponding to the depth data set.

3. The training method of the depth estimation model according to claim 1, wherein the performing mean-shift on the first depth data to obtain second depth data comprises:
initializing a bandwidth threshold;
taking, based on a Gaussian function, a weighted average value of distances between a current data point and data points within a range corresponding to the bandwidth threshold as a current density value;
updating all data points according to the weighted average value, after multiple iterations, determining converged points as clustering centers, and classifying points converging to a same clustering center into one cluster; and
for a clustering center of each cluster, determining cosine similarity between the clustering center and each data point, and selecting data that is most similar to the clustering center to obtain the second depth data.

4. The training method of the depth estimation model according to claim 1, wherein the performing necessity assessment on the first depth data by using the metric depth model to obtain the selective depth data comprises:
inputting the first depth data into the metric depth model, and determining data having a data error predicted by the metric depth model higher than or equal to a preset threshold as the selective depth data.

5. The training method of the depth estimation model according to claim 1, wherein the training the depth estimation model by using the selective depth data comprises:
training the depth estimation model by using the selective depth data and a joint supervision function, wherein the joint supervision function comprises a gradient angle function, the gradient angle function constrains an absolute error loss between angles of a depth gradient in length and width directions and an angle of a true depth gradient.

6. The training method of the depth estimation model according to claim 5, wherein the joint supervision function further comprises a scale shift invariant loss function, a scale-invariant logarithmic loss function and a random proposal normalization loss function.

7. A training method of a depth estimation model, comprising:
determining a joint supervision function, wherein the joint supervision function comprises a gradient angle function, the gradient angle function constrains an absolute error loss between angles of a depth gradient in length and width directions and an angle of a true depth gradient; and
training the depth estimation model by using the joint supervision function to obtain a trained depth estimation model.

8. A terminal, comprising:
at least one memory and at least one processor;
wherein the at least one memory is configured to store program code, and the at least one processor is configured to call the program code stored by the at least one memory to execute a training method of a depth estimation model, which comprises:
acquiring selective depth data;
training the depth estimation model by using the selective depth data to obtain a trained depth estimation model;
wherein the acquiring selective depth data comprises:
acquiring a depth data set;
performing quality assessment on the depth data set to obtain first depth data;
performing mean-shift on the first depth data to obtain second depth data;
performing fine-tuning on a pre-training depth model by using the second depth data to obtain a metric depth model; and
performing necessity assessment on the first depth data by using the metric depth model to obtain the selective depth data.

9. The terminal according to claim 8, wherein the performing quality assessment on the depth data set to obtain first depth data comprises:
training a known model by using the depth data set, and assessing a quality of the depth data set based on zero-shot result data of the known model on different depth data sets, and coverage, density and quantity corresponding to the depth data set.

10. The terminal according to claim 8, wherein the performing mean-shift on the first depth data to obtain second depth data comprises:
initializing a bandwidth threshold;
taking, based on a Gaussian function, a weighted average value of distances between a current data point and data points within a range corresponding to the bandwidth threshold as a current density value;
updating all data points according to the weighted average value, after multiple iterations, determining converged points as clustering centers, and classifying points converging to a same clustering center into one cluster; and
for a clustering center of each cluster, determining cosine similarity between the clustering center and each data point, and selecting data that is most similar to the clustering center to obtain the second depth data.

11. The terminal according to claim 8, wherein the performing necessity assessment on the first depth data by using the metric depth model to obtain the selective depth data comprises:
inputting the first depth data into the metric depth model, and determining data having a data error predicted by the metric depth model higher than or equal to a preset threshold as the selective depth data.

12. The terminal according to claim 8, wherein the training the depth estimation model by using the selective depth data comprises:
training the depth estimation model by using the selective depth data and a joint supervision function, wherein the joint supervision function comprises a gradient angle function, the gradient angle function constrains an absolute error loss between angles of a depth gradient in length and width directions and an angle of a true depth gradient.

13. The terminal according to claim 12, wherein the joint supervision function further comprises a scale shift invariant loss function, a scale-invariant logarithmic loss function and a random proposal normalization loss function.

14. A terminal, comprising:
at least one memory and at least one processor;
wherein the at least one memory is configured to store program code, and the at least one processor is configured to call the program code stored by the at least one memory to execute the training method of the depth estimation model according to claim 7.

15. A non-transitory storage medium, wherein the non-transitory storage medium is used to storage program code, and the program code is used to execute the training method of the depth estimation model according to claim 1.

16. The non-transitory storage medium according to claim 15, wherein the performing quality assessment on the depth data set to obtain first depth data comprises:
training a known model by using the depth data set, and assessing a quality of the depth data set based on zero-shot result data of the known model on different depth data sets, and coverage, density and quantity corresponding to the depth data set.

17. The non-transitory storage medium according to claim 15, wherein the performing mean-shift on the first depth data to obtain second depth data comprises:
initializing a bandwidth threshold;
taking, based on a Gaussian function, a weighted average value of distances between a current data point and data points within a range corresponding to the bandwidth threshold as a current density value;
updating all data points according to the weighted average value, after multiple iterations, determining converged points as clustering centers, and classifying points converging to a same clustering center into one cluster; and
for a clustering center of each cluster, determining cosine similarity between the clustering center and each data point, and selecting data that is most similar to the clustering center to obtain the second depth data.

18. The non-transitory storage medium according to claim 15, wherein the performing necessity assessment on the first depth data by using the metric depth model to obtain the selective depth data comprises:
inputting the first depth data into the metric depth model, and determining data having a data error predicted by the metric depth model higher than or equal to a preset threshold as the selective depth data.

19. The non-transitory storage medium according to claim 15, wherein the training the depth estimation model by using the selective depth data comprises:
training the depth estimation model by using the selective depth data and a joint supervision function, wherein the joint supervision function comprises a gradient angle function, the gradient angle function constrains an absolute error loss between angles of a depth gradient in length and width directions and an angle of a true depth gradient.

20. A non-transitory storage medium, wherein the non-transitory storage medium is used to storage program code, and the program code is used to execute the training method of the depth estimation model according to claim 7.
